(19) United States
(12) Patent Application Publication
(10) Pub. No.: US 2022/0394163 A1
(43) Pub. Date: Dec. 8, 2022

(54) OPTICAL ACTUATOR, CAMERA MODULE, AND CAMERA-MOUNTED APPARATUS

(71) Applicant: Yukihiro TAKIMOTO, Tokyo (JP)

(72) Inventor: Yukihiro TAKIMOTO, Tokyo (JP)

(73) Assignee: Mitsumi Electric Co., Ltd., Tokyo (JP)

(21) Appl. No.: 17/832,726

(22) Filed: Jun. 6, 2022

(30) Foreign Application Priority Data
Jun. 8, 2021 (JP) 2021-095916

(51) Int. Cl. H04N 5/225; H02K 41/035

(52) U.S. Cl. CPC H04N 5/2257; H04N 5/2252; H04N 5/2254; H04N 5/2253; H02K 41/0354

(57) ABSTRACT

Provided is an optical actuator that includes an elastic support member having a small influence on the drivability of a lens guide and having a high durability by configuring the optical actuator to include: a fixed-side member; a movable-side member that is arranged apart from the fixed-side member in a first direction orthogonal to an optical axis, holds a lens part, and moves by power of a driving part; and an elastic support member that supports the movable-side member with respect to the fixed-side member, and by configuring the optical actuator such that the elastic support member includes an elastic deformation part formed by at least a pair of linear parts arranged so as to follow each other in a state of having an interval between the pair of linear parts.

### CROSS REFERENCE TO RELATED APPLICATIONS

This application is entitled to and claims the benefit of Japanese Patent Application No. 2021-95916, filed on Jun. 8, 2021, the disclosure of which including the specification, drawings and abstract is incorporated herein by reference in its entirety.

### TECHNICAL FIELD

The present invention relates to an optical actuator, a camera module, and a camera-mounted apparatus.

### BACKGROUND ART

In the related art, a thin camera-mounted apparatus in which a camera module is mounted, such as a smartphone and a digital camera, has been known. The camera module includes: a lens part including one or more lenses; and an imaging element that captures a subject image formed by the lens part.

Further, a camera module including a bending optical system, in which light from a subject along a first optical axis is bent in a direction of a second optical axis and is guided to a lens part through a prism that is an optical path bending member provided at a stage prior to the lens part, has also been proposed (for example, Patent Literature (hereinafter, referred to as “PTL”) 1).

The camera module disclosed in PTL 1 includes an autofocus apparatus that performs autofocusing. Such a camera module includes: a base; a lens guide that holds a lens; an elastic support member that elastically supports the lens guide with respect to the base; and an autofocus actuator that moves the lens guide in a direction of an optical axis.

### CITATION LIST

### Patent Literature

### PTL 1

### Japanese Patent Application Laid-Open No. 2019-139223

### SUMMARY OF INVENTION

### Technical Problem

In the case of the camera actuator as described above, the elastic support member has a function of supporting the lens guide with respect to the base and a function of absorbing an impact applied to the camera module. As such an elastic support member, an elastic support member having a small influence on the drivability of the lens guide and having a high durability is desired. It is conceivable to reduce the width dimension of the elastic support member for reducing the influence on the drivability of the lens guide. When the width dimension of the elastic support member is small, however, the durability may decrease.

An object of the present invention is to provide an optical actuator, a camera module, and a camera-mounted apparatus each including an elastic support member having a small influence on the drivability of a lens guide and having a high durability.

### Solution to Problem

One aspect of an optical actuator according to the present invention includes: a fixed-side member; a movable-side member that is arranged apart from the fixed-side member in a first direction orthogonal to an optical axis, holds a lens part, and moves by power of a driving part; and an elastic support member that supports the movable-side member with respect to the fixed-side member. The elastic support member includes an elastic deformation part formed by at least a pair of linear parts arranged so as to follow each other in a state of having an interval between the pair of linear parts.

One aspect of a camera module according to the present invention includes: the optical actuator described above; and an imaging element arranged at a stage subsequent to the lens part.

One aspect of a camera-mounted apparatus according to the present invention includes: the camera module described above; and a control part that controls the camera module.

### Advantageous Effects of Invention

According to the present invention, it is possible to provide an optical actuator, a camera module, and a camera-mounted apparatus each including an elastic support member having a small influence on the drivability of a lens guide and having a high durability.

### BRIEF DESCRIPTION OF DRAWINGS

FIG. 1 is a perspective view schematically illustrating a camera module according to an embodiment of the present invention;

FIG. 2 is a perspective view of the camera module from which a cover is omitted;

FIG. 3 is a perspective view of the camera module from which the cover and a sensor holding part are omitted;

FIG. 4 is a perspective view of the camera module from which the cover and a lens guide are omitted;

FIG. 5 is a perspective view of the lens guide and members fixed to the lens guide;

FIG. 6 is a perspective view of the lens guide and the members fixed to the lens guide;

FIG. 7 is a perspective view of springs;

FIG. 8A illustrates an example of a camera-mounted apparatus in which the camera module is mounted;

FIG. 8B illustrates an example of the camera-mounted apparatus in which the camera module is mounted;

FIG. 9A illustrates an automobile as the camera-mounted apparatus in which an in-vehicle camera module is mounted; and

FIG. 9B illustrates the automobile as the camera-mounted apparatus in which the in-vehicle camera module is mounted.

### DESCRIPTION OF EMBODIMENTS

Hereinafter, embodiments according to the present invention will be described in detail with reference to the accompanying drawings. Note that, an optical actuator, a camera module, and a camera-mounted apparatus according to an embodiment to be described later are examples of the optical actuator, the camera module, and the camera-mounted apparatus according to the present invention, and the present invention is not limited by the embodiment.

### Embodiment

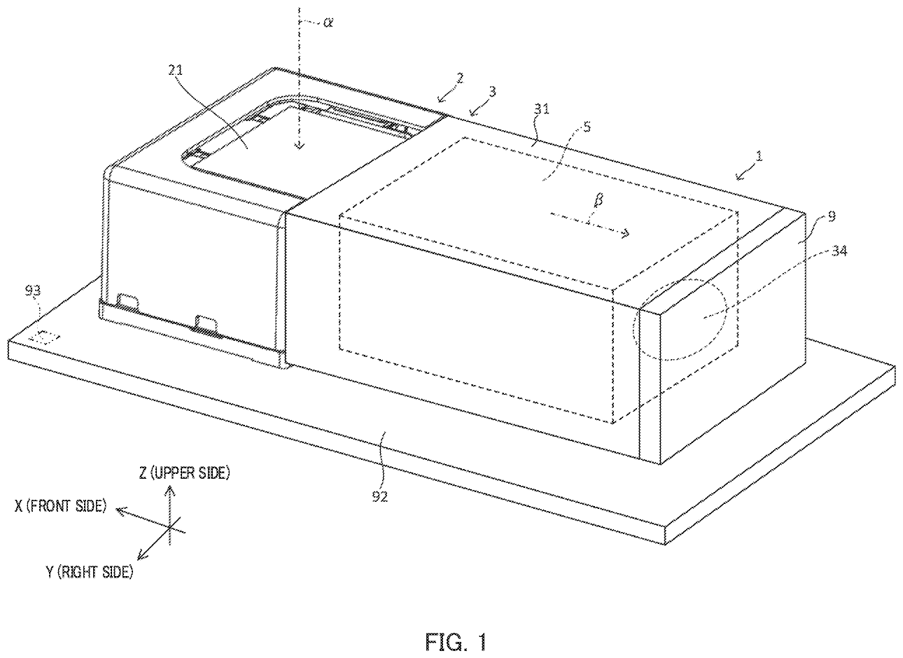

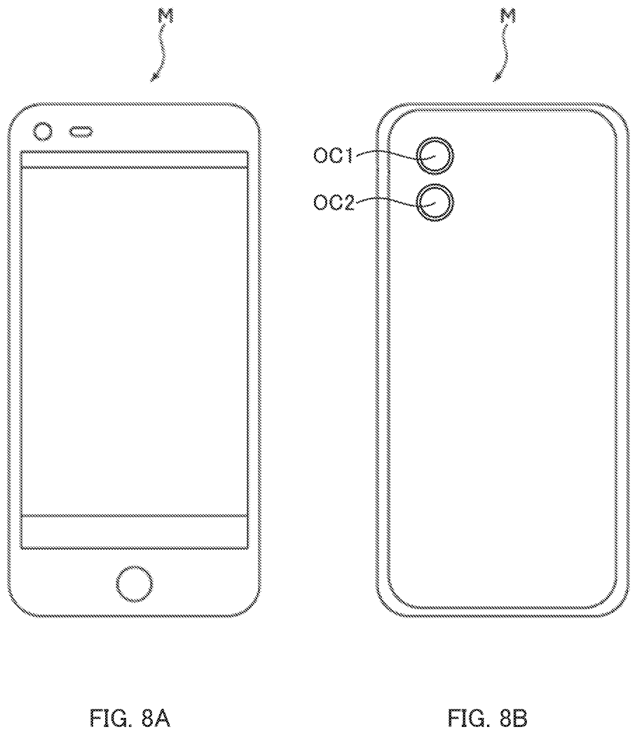

Camera module 1 according to an embodiment of the present invention will be described with reference to FIGS. 1 to 7. Camera module 1 is mounted in, for example, smartphone M (see FIGS. 8A and 8B), a mobile phone, a digital camera, a notebook computer, a tablet terminal, a portable game machine, and a thin camera-mounted apparatus (such as an in-vehicle camera). Smartphone M includes a dual camera formed of two rear cameras OC1 and OC2. Camera module 1 according to the present embodiment is applied to at least one camera of rear cameras OC1 and OC2.

Camera module 1 includes optical path bending module 2, lens module 3, and imaging element module 9. Note that, the optical actuator, the camera module, and the camera-mounted apparatus according to the present invention may include all configurations to be described later or may not include some of the configurations.

Hereinafter, each component that forms camera module 1 of the present embodiment will be described based on a state in which each component is incorporated in camera module 1. Further, in the description of the structure of camera module 1 of the present embodiment, an orthogonal coordinate system (X, Y, Z) indicated in each drawing is used.

In the present embodiment, the Z direction corresponds to an example of the first direction. Further, the X direction corresponds to an example of a second direction. The Y direction corresponds to an example of a third direction. Further, the XY plane is a plane orthogonal to the first direction. The YZ plane is a plane orthogonal to the second direction. The XZ plane is a plane orthogonal to the third direction.

In a case where the camera-mounted apparatus is used to take a picture in practice, camera module 1 is mounted such that the X direction is the left-right direction, the Y direction is the up-down direction, and the Z direction is the front-rear direction, for example. Light (incident light) from a subject enters prism 21 of optical path bending module 2 from the +side (plus side) in the Z direction as indicated by long dashed short dashed line α (also referred to as the first optical axis) in FIG. 1. Prism 21 is an example of the optical path bending member.

Light (emission light) that has entered prism 21 is bent on an optical path bending surface of prism 21 as indicated by long dashed short dashed line β (also referred to as the second optical axis) in FIG. 1 and is guided to lens part 34 of lens module 3 arranged at a stage subsequent to (on the −side in the X direction of) prism 21.

Then a subject image formed by lens part 34 is captured by imaging element module 9 (see FIG. 1) arranged at a stage subsequent to lens module 3. As the configurations of optical path bending module 2 and imaging element module 9 in camera module 1 of the present embodiment, various configurations known in the related art can be employed. Hereinafter, a specific configuration of lens module 3 will be described.

Lens module 3 includes cover 31, base 32, FPC 33, lens part 34, and AF apparatus 4.

As illustrated in FIG. 1, cover 31 is a box-shaped member that is made of, for example, a synthetic resin or a nonmagnetic metal, and is open on the both sides in the front-rear direction and on the lower side.

Base 32 corresponds to an example of the fixed-side member and is combined with cover 31 to thereby form an accommodation space in which lens part 34 and AF apparatus 4 can be arranged. Base 32 supports lens guide 5 via springs 8a to 8d to be described later.

Base 32 includes bottom wall part 321, left wall part 322, and right wall part 323.

Bottom wall part 321 has a rectangular plate shape parallel to the XY plane. Bottom wall part 321 forms a bottom part of base 32.

Note that, hereinafter, the left-right direction means the left-right direction in a case where lens module 3 is viewed from the +side in the X direction with the +side in the Z direction facing upward, for convenience. Accordingly, the +side in the Y direction corresponds to the right side, and the −side in the Y direction corresponds to the left side. Further, in lens module 3, the +side in the X direction corresponds to the front side, and the −side in the X direction corresponds to the rear side. In addition, in lens module 3, the +side in the Z direction corresponds to the upper side, and the −side in the Z direction corresponds to the lower side.

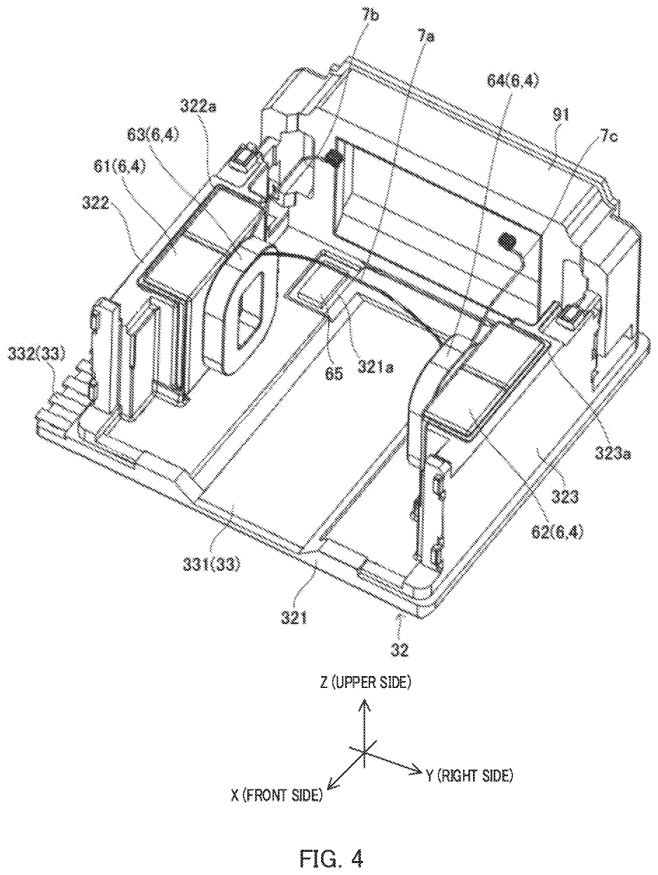

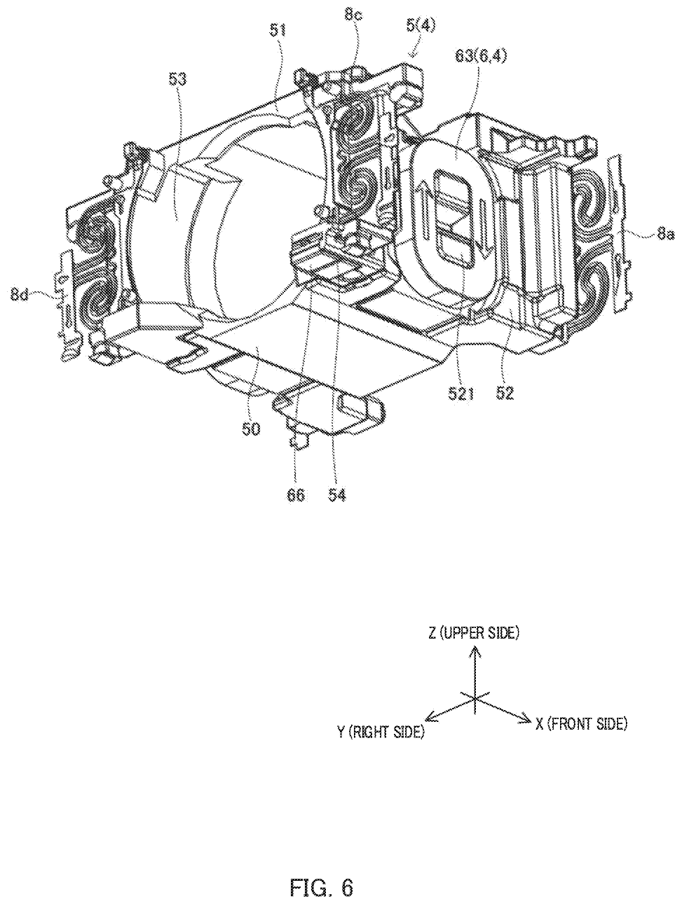

FPC 33 is insert-molded in bottom wall part 321. FPC 33 will be described later. Bottom wall part 321 includes element arrangement part 321a (see FIG. 4) for arranging position detection element 65. Element arrangement part 321a faces magnet arrangement part 54 (see FIG. 6) of lens guide 5 with a gap therebetween in the up-down direction.

Sensor holding part 91 of imaging element module 9 is fixed to a rear end part of bottom wall part 321.

Left wall part 322 corresponds to an example of a first wall part of the base and has a plate shape parallel to the XZ plane. Left wall part 322 extends upward from a left end part of bottom wall part 321. Left wall part 322 includes left-side magnet holding part 322a on the right side surface (also referred to as the inner side surface). Left-side magnet 61 of AF apparatus 4 to be described later is fixed to left-side magnet holding part 322a.

Right wall part 323 corresponds to an example of a second wall part of the base and has a plate shape parallel to the XZ plane. Right wall part 323 extends upward from a right end part of bottom wall part 321. Right wall part 323 includes right-side magnet holding part 323a on the left side surface (also referred to as the inner side surface). Right-side magnet 62 of AF apparatus 4 to be described later is fixed to right-side magnet holding part 323a.

FPC 33 has a plate shape parallel to the XY plane and is fixed to bottom wall part 321 of base 32. FPC 33 includes board 331, first terminal part 332, first connection part 333, and second connection part 334.

Board 331 is embedded in bottom wall part 321 of base 32 and includes a plurality of wirings (not illustrated).

First terminal part 332 is formed of a plurality of terminals that are connected to sensor board 92 (see FIG. 1) where camera module 1 is mounted. First terminal part 332 includes a base end part embedded in bottom wall part 321 of base 32. First terminal part 332 includes a leading end part protruding from the left end part of bottom wall part 321.

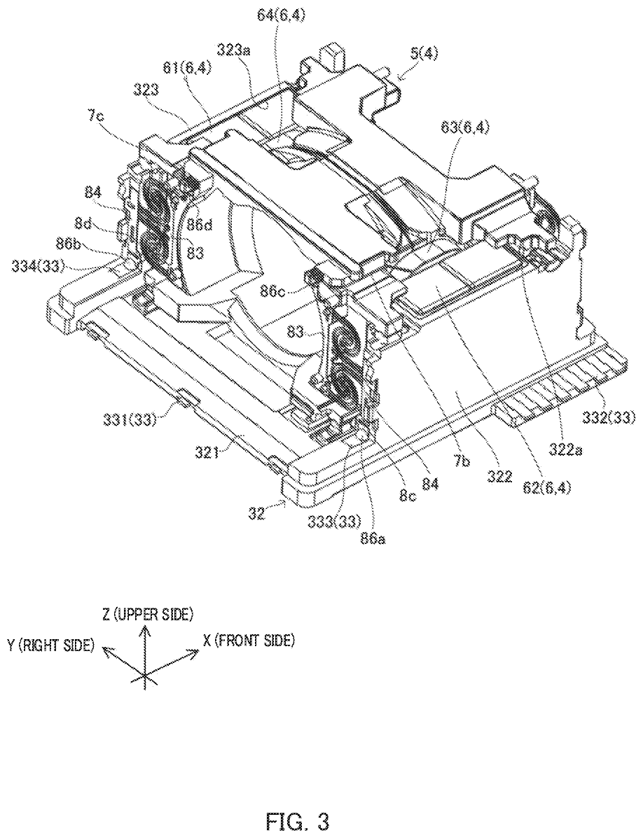

First connection part 333 is exposed from base 32 near a lower end part of a rear end surface of left wall part 322 (see FIG. 3). First connection part 333 is connected to a terminal(s) of first terminal part 332 via the wirings of board 331, where the terminal(s) is/are connected to the negative side of a power supply. Inner-side fixing part 80 of spring 8c to be described later is connected to first connection part 333 via solder 86a.

Second connection part 334 is exposed from base 32 near a lower end part of a rear end surface of right wall part 323 (see FIG. 3). Second connection part 334 is connected to a terminal(s) of first terminal part 332 via the wirings of board 331, where the terminal(s) is/are connected to the positive side of the power supply. Inner-side fixing part 80 of spring 8d to be described later is connected to second connection part 334 via solder 86b.

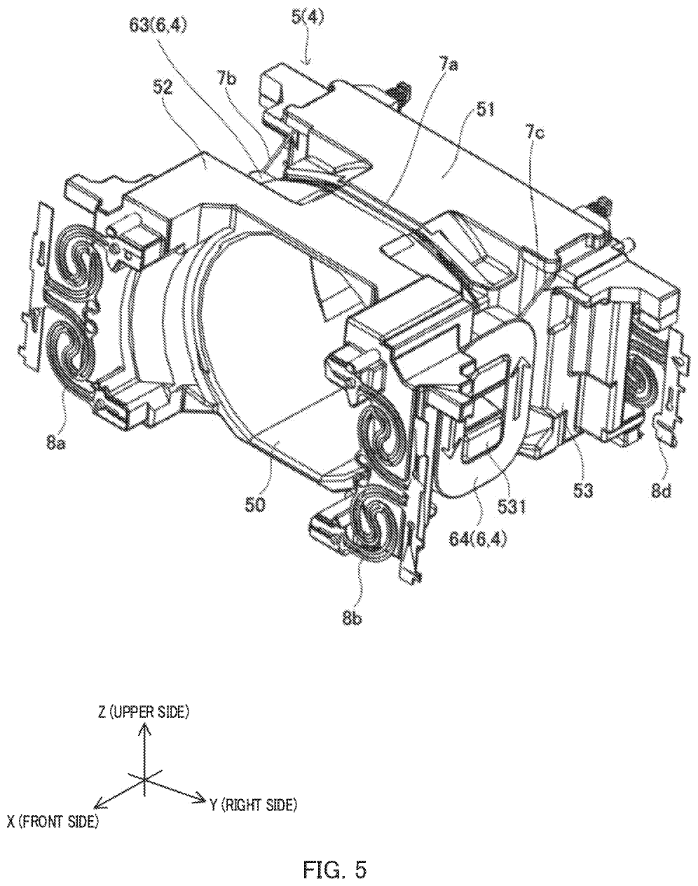

First connection part 333 and second connection part 334 are connected to each other via spring 8c, connection line 7b (see FIG. 5), left-side coil 63, connection line 7a (see FIG. 5), right-side coil 64, connection line 7c (see FIG. 5), and spring 8d.

Lens part 34 is held by lens guide 5. Lens part 34 includes a lens barrel having a cylindrical shape and one or more lenses held by the lens barrel. For example, lens part 34 includes, for example, a 3x or more optical telephoto lens group fixed between the end part of the lens barrel on the −side in the X direction and the end part of the lens barrel on the +side in the X direction.

AF apparatus 4 moves lens part 34 in a direction (the X direction) parallel to the second optical axis for the purpose of autofocusing. Specifically, AF apparatus 4 includes lens guide 5, AF actuator 6, and a plurality (four in the case of the present embodiment) of springs 8a, 8b, 8c, and 8d.

Lens guide 5 holds the lens barrel of lens part 34. Lens guide 5 is supported by base 32 via springs 8a to 8d in a state in which lens guide 5 is capable of moving at least in a direction of the second optical axis (the X direction). Lens guide 5 is apart upward from base 32.

Lens guide 5 corresponds to an example of the movable-side member and has a box shape that is open frontward and rearward. Lens guide 5 includes bottom wall part 50, upper wall part 51, left wall part 52, and right wall part 53.

Bottom wall part 50 faces bottom wall part 321 of base 32 with a gap therebetween in the up-down direction. Bottom wall part 50 includes magnet arrangement part 54 (see FIG. 6) on the lower surface. Magnet arrangement part 54 faces element arrangement part 321a of base 32 in the up-down direction. Position detection magnet 66 is fixed to magnet arrangement part 54 via a yoke.

Left wall part 52 is arranged on the right side of left wall part 322 of base 32 and faces left wall part 322 of base 32 with a gap therebetween in the left-right direction. Left wall part 52 includes left-side coil fixing part 521 on the left side surface (also referred to as the outer side surface). Left-side coil 63 of AF actuator 6 is fixed to left-side coil fixing part 521.

Right wall part 53 is arranged on the left side of right wall part 323 of base 32, and faces right wall part 323 of base 32 with a gap therebetween in the left-right direction. Right wall part 53 includes right-side coil fixing part 531 on the right side surface (also referred to as the outer side surface). Right-side coil 64 of AF actuator 6 is fixed to right-side coil fixing part 531.

Lens guide 5 holds lens part 34 in a cylindrical space defined by bottom wall part 50, upper wall part 51, left wall part 52, and right wall part 53.

AF actuator 6 corresponds to an example of the driving part and is an actuator for moving lens guide 5 in the direction of the second optical axis (the X direction).

AF actuator 6 includes left-side magnet 61, right-side magnet 62, left-side coil 63, right-side coil 64, position detection magnet 66, and position detection element 65.

Left-side magnet 61 and left-side coil 63 form a voice coil motor on the left side, and right-side magnet 62 and right-side coil 64 form a voice coil motor on the right side. That is, AF actuator 6 is formed of a pair of voice coil motors.

Left-side magnet 61 is fixed to left-side magnet holding part 322a of base 32 via a yoke. Left-side magnet 61 is formed of a pair of magnet elements having a cuboid shape whose longitudinal direction coincides with the up-down direction and whose transverse direction coincides with the front-rear direction. The pair of magnet elements is arranged side by side in the front-rear direction. Each of the pair of magnet elements is magnetized in the left-right direction and includes one magnetic pole on one side. The directions of the magnetic poles of the pair of magnet elements are opposite to each other. Left-side magnet 61 faces left-side coil 63 with a gap therebetween in the left-right direction.

Right-side magnet 62 is fixed to right-side magnet holding part 323a of base 32 via a yoke. Right-side magnet 62 is formed of a pair of magnet elements having a cuboid shape whose longitudinal direction coincides with the up-down direction and whose transverse direction coincides with the front-rear direction. The pair of magnet elements is arranged side by side in the front-rear direction. Each of the pair of magnet elements is magnetized in the left-right direction and includes one magnetic pole on one side. The directions of the magnetic poles of the pair of magnet elements are opposite to each other. Right-side magnet 62 faces right-side coil 64 with a gap therebetween in the left-right direction.

Left-side coil 63 is a so-called air-core coil having an elliptical shape, to which power is supplied during AF. Left-side coil 63 is fixed to left-side coil fixing part 521 of lens guide 5 in a state in which the long axis of left-side coil 63 coincides with the up-down direction. A first end part of left-side coil 63 is connected to a first end part of right-side coil 64 via connection line 7a. Connection line 7a is provided so as to be along the upper surface of upper wall part 51 of lens guide 5 from left-side coil 63 toward right-side coil 64. Further, a second end part of left-side coil 63 is connected to outer-side fixing part 81 of spring 8c via connection line 7b. Connection line 7b extends rearward from left-side coil 63 toward outer-side fixing part 81 of spring 8c.

Right-side coil 64 is a so-called air-core coil having an elliptical shape, to which power is supplied during AF. Right-side coil 64 is fixed to right-side coil fixing part 531 of lens guide 5 in a state in which the long axis of right-side coil 64 coincides with the up-down direction. A second end of right-side coil 64 is connected to outer-side fixing part 81 of spring 8d via connection line 7c. Connection line 7c extends rearward from right-side coil 64 toward outer-side fixing part 81 of spring 8d.

Position detection magnet 66 is fixed to magnet arrangement part 54 of lens guide 5 via a yoke. Position detection magnet 66 is formed of a pair of magnet elements having a cuboid shape whose longitudinal direction coincides with the left-right direction and whose transverse direction coincides with the front-rear direction. The pair of magnet elements is arranged side by side in the front-rear direction. Each of the pair of magnet elements is magnetized in the up-down direction and includes one magnetic pole on one side. The directions of the magnetic poles of the pair of magnet elements are opposite to each other. Position detection magnet 66 faces position detection element 65 with a gap therebetween in the up-down direction.

Position detection element 65 is fixed to board 331 of FPC 33 in a state in which position detection element 65 is arranged in element arrangement part 321a of base 32. Position detection element 65 is connected to the power supply and to control part 93 mounted in sensor board 92 via the wirings of board 331 and the terminals of first terminal part 332.

Position detection element 65 detects a magnetic flux of position detection magnet 66 and sends the detected value to control part 93. In the case of the present embodiment, position detection element 65 detects a change in a magnetic flux passing through a detection surface of position detection element 65. When lens guide 5 moves from a reference position, at which the movement distance of lens guide 5 in the direction (the X direction) parallel to the direction of the second optical axis is zero, in the direction (the X direction) parallel to the second optical axis, position detection magnet 66 moves together with lens guide 5 and a magnetic flux passing through the detection surface of position detection element 65 changes. Control part 93 calculates the position of position detection magnet 66 (lens guide 5) in the direction (the X direction) parallel to the second optical axis based on the detected value received from position detection element 65.

In the case of AF actuator 6 having the configuration as described above, when a current flows through left-side coil 63 and right-side coil 64, a Lorentz force that moves left-side coil 63 and right-side coil 64 in the X direction is generated. As a result, lens guide 5 to which left-side coil 63 and right-side coil 64 are fixed moves in the X direction. Autofocusing is performed in this way.

As described above, AF actuator 6 according to the present embodiment is a moving coil-type actuator in which left-side coil 63 and right-side coil 64 are fixed to lens guide 5, which is the movable-side member, and left-side magnet 61 and right-side magnet 62 are fixed to base 32, which is the fixed-side member. The weights of left-side coil 63 and right-side coil 64 are smaller than the weights of left-side magnet 61 and right-side magnet 62 so that the total weight of members that move during autofocusing can be reduced in comparison with a moving magnet-type actuator. As a result, it is possible to achieve miniaturization of AF actuator 6 and power saving of camera module 1.

Each of springs 8a to 8d corresponds to an example of the elastic support member and has a function of elastically supporting lens guide 5 with respect to base 32. Further, springs 8a to 8d have a function to absorbing an impact in a case where the impact is applied to camera module 1 due to a drop or the like.

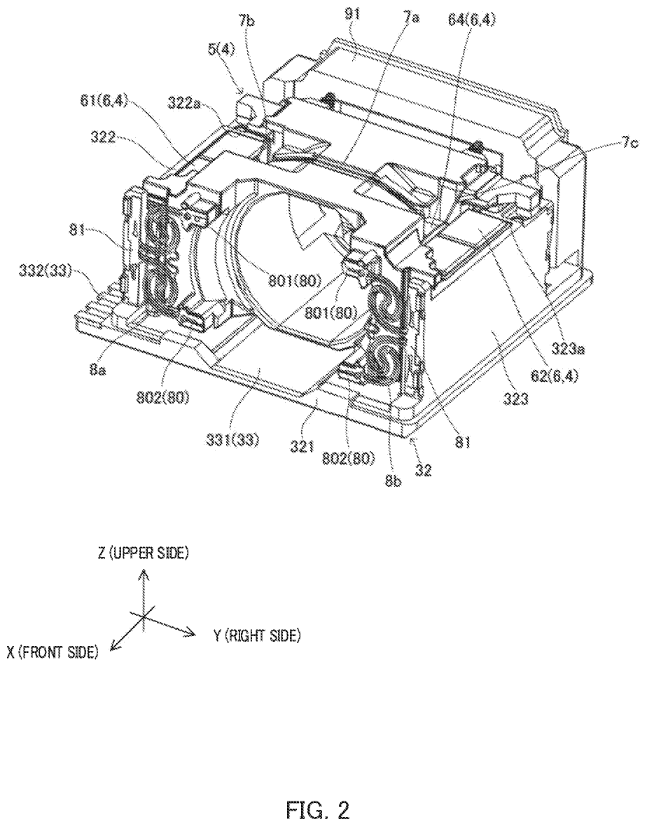

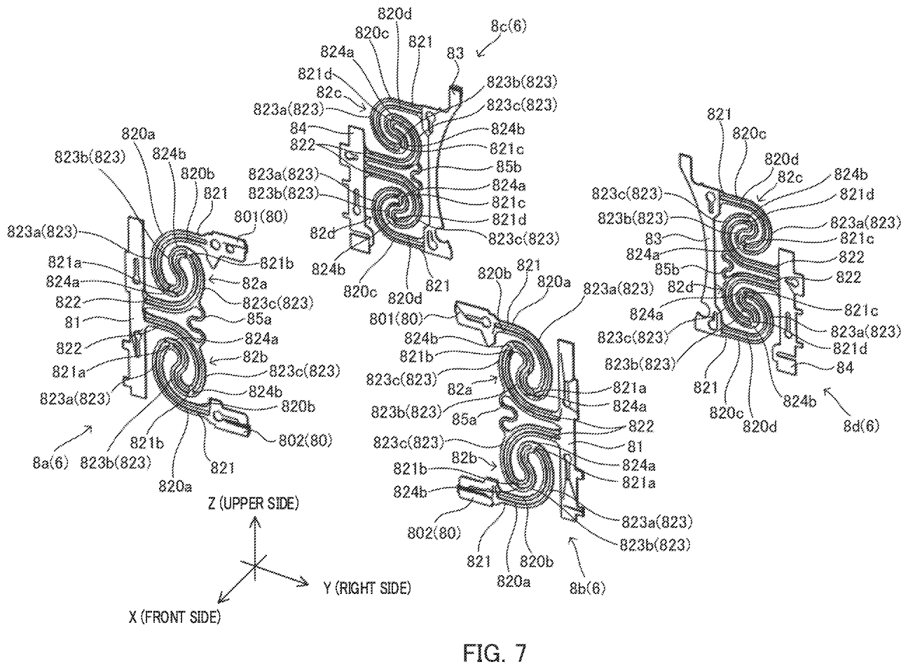

Spring 8a supports a left end part of a front end part of lens guide 5 with respect to base 32 (see FIGS. 2 and 7). Spring 8b supports a right end part of the front end part of lens guide 5 with respect to base 32 (see FIGS. 2 and 7). Spring 8c supports a left end part of a rear end part of lens guide 5 with respect to base 32 (see FIGS. 3 and 7). Further, spring 8d supports a right end part of the rear end part of lens guide 5 with respect to base 32 (see FIGS. 3 and 7). Note that, FIG. 7 illustrates springs 8a to 8d as arranged in the assembled state.

As illustrated in FIG. 7, each of springs 8a to 8d is a plate spring and is arranged on a plane parallel to the YZ plane.

Springs 8a and 8b have a symmetrical shape in the left-right direction. Further, springs 8c and 8d have a symmetrical shape in the left-right direction.

First, springs 8a and 8b will be described, and thereafter springs 8c and 8d will be described. Duplicate descriptions of structures common to springs 8a to 8d will be omitted as appropriate.

Each of spring 8a and 8b includes inner-side fixing part 80, outer-side fixing part 81, a pair of elastic deformation parts 82a and 82b, and connection part 85a.

Inner-side fixing part 80 is fixed to lens guide 5. Specifically, inner-side fixing part 80 includes upper-side fixing part 801 and lower-side fixing part 802.

Upper-side fixing part 801 of spring 8a is fixed to an upper end part of a front end surface of left wall part 52 in lens guide 5. Lower-side fixing part 802 of spring 8a is fixed to a lower end part of the front end surface of left wall part 52 in lens guide 5. Upper-side fixing part 801 and lower-side fixing part 802 of spring 8a are provided with an interval therebetween in the up-down direction.

Upper-side fixing part 801 of spring 8b is fixed to an upper end part of a front end surface of right wall part 53 in lens guide 5. Lower-side fixing part 802 of spring 8b is fixed to a lower end part of the front end surface of right wall part 53 in lens guide 5.

Outer-side fixing part 81 is fixed to base 32. Outer-side fixing part 81 has a plate shape extending in the up-down direction. Outer-side fixing part 81 of spring 8a is fixed to a front end surface of left wall part 322 in base 32. Further, outer-side fixing part 81 of spring 8b is fixed to a front end surface of right wall part 323 in base 32.

The position of an upper end part of outer-side fixing part 81 in the up-down direction is the same or substantially the same as the position of upper-side fixing part 801 of inner-side fixing part 80 in the up-down direction. The position of a lower end part of outer-side fixing part 81 in the up-down direction is the same or substantially the same as the position of lower-side fixing part 802 of inner-side fixing part 80 in the up-down direction.

Each pair of elastic deformation parts 82a and 82b of springs 8a and 8b is arranged side by side in a state of having an interval therebetween in the up-down direction, and connects inner-side fixing part 80 and outer-side fixing part 81. Specifically, elastic deformation part 82a on the upper side connects upper-side fixing part 801 and outer-side fixing part 81. Further, elastic deformation part 82b on the lower side connects lower-side fixing part 802 and outer-side fixing part 81. Note that, elastic deformation part 82a on the upper side corresponds to an example of a first elastic deformation part. Further, elastic deformation part 82b on the lower side corresponds to an example of a second elastic deformation part.

The pair of elastic deformation parts 82a and 82b has a symmetrical shape with respect to each other in the up-down direction. That is, the shape of elastic deformation part 82a in a case where elastic deformation part 82a is inverted in the up-down direction with an imaginary straight line parallel to the left-right direction as an axis is the same as the shape of elastic deformation part 82b.

Each of elastic deformation parts 82a and 82b includes: at least a pair of linear parts 820a and 820b so as to follow each other in a state of having an interval therebetween; and two intermediate connection parts 821a and 821b that connect intermediate parts of the pair of linear parts 820a and 820b in a length direction of the pair of linear parts 820a and 820b to each other.

Note that, the number of linear parts is not limited to two, but may be more than two. Further, the number of intermediate connection parts is not limited to two, but may be one or may be three or more. Further, the intermediate connection part(s) may be omitted.

Hereinafter, the dimension of the pair of linear parts 820a and 820b in the front-rear direction is defined as a thickness dimension of elastic deformation parts 82a and 82b (the pair of linear parts 820a and 820b). Further, the dimension of the pair of linear parts 820a and 820b in a direction orthogonal to the extension direction of the pair of linear parts 820a and 820b and the front-rear direction is defined as a width dimension of elastic deformation parts 82a and 82b (the pair of linear parts 820a and 820b).

The pair of linear parts 820a and 820b is provided so as to follow each other in a state of having an interval therebetween in the width direction of the pair of linear parts 820a and 820b. The interval between the pair of linear parts 820a and 820b in the width direction thereof may be constant or may partially change.

In the case of the present embodiment, the thickness dimension of the pair of linear parts 820a and 820b is smaller than the width dimension of the pair of linear parts 820a and 820b. Further, a spring constant of the pair of linear parts 820a and 820b in the front-rear direction is smaller than a spring constant of the pair of linear parts 820a and 820b in the direction orthogonal to the front-rear direction. Such a configuration is common to springs 8a to 8d and contributes to both reducing the influence on the drivability of lens guide 5 by springs 8a to 8d and improving the durability of springs 8a to 8d.

Hereinafter, a specific configuration of elastic deformation parts 82a and 82b will be described. The term: elastic deformation part in the following description, however, may be appropriately replaced with the term: pair of linear parts.

Elastic deformation part 82a includes a first end part connected to upper-side fixing part 801, and a second end part connected to outer-side fixing part 81. The second end part is connected to a substantially central part of outer-side fixing part 81 in the up-down direction. The second end part of elastic deformation part 82a is arranged downward from the first end part of elastic deformation part 82a.

Elastic deformation part 82b includes a first end part connected to lower-side fixing part 802, and a second end part connected to outer-side fixing part 81. In a substantially central part of outer-side fixing part 81 in the up-down direction, the second end part is connected to a position slightly downward from the position to which the second end part of elastic deformation part 82a is connected. The second end part of the elastic deformation part 82b is arranged upward from the first end part of the elastic deformation part 82b.

Each of elastic deformation parts 82a and 82b includes: first straight line part 821 including the first end part; second straight line part 822 including the second end part; and meandering part 823 that connects first straight line part 821 and second straight line part 822.

First straight line part 821 extends, in a state of being parallel to the left-right direction, from each first end part of elastic deformation parts 82a and 82b toward outer-side fixing part 81. Second straight line part 822 extends, in a state of being parallel to the left-right direction, from each second end part of elastic deformation parts 82a and 82b toward inner-side fixing part 80.

Meandering part 823 is provided between first straight line part 821 and second straight line part 822 and meanders in a substantially S-shape. Specifically, meandering part 823 includes, in order nearest to each first end part of elastic deformation parts 82a and 82b, first curved part 823a, second curved part 823b, and third curved part 823c.

First curved part 823a is curved with a predetermined curvature. Second curved part 823b is gently curved in a substantially S-shape. Third curved part 823c is curved with a predetermined curvature. The curvature of first curved part 823a and the curvature of third curved part 823c are the same or substantially the same.

Further, portions corresponding to a connection part between first curved part 823a and second curved part 823b and a connection part between second curved part 823b and third curved part 823c are maximum curvature parts 824a and 824b curved at the maximum curvature in elastic deformation part 82a.

Intermediate parts of the pair of linear parts 820a and 820b in the length direction of the pair of linear parts 820a and 820b are connected to each other by intermediate connection parts 821a and 821b in the width direction of the pair of linear parts 820a and 820b. Such a configuration is a structure common to springs 8a to 8d and contributes to improving the durability of springs 8a to 8d and suppressing contact of the pair of linear parts 820a and 820b with each other.

Further, connection part 85a connects the pair of elastic deformation parts 82a and 82b to each other in the up-down direction. Specifically, connection part 85a connects meandering parts 823 (specifically, third curved parts 823c) in the pair of elastic deformation parts 82a and 82b to each other in the up-down direction.

Connection part 85a has a meandering shape folded a plurality of times in the left-right direction and is elastically deformable. The width dimension of connection part 85a is smaller than the width dimension of the pair of elastic deformation parts 82a and 82b. Such a configuration of connection part 85a is common to springs 8a to 8d. Connection part 85a achieves improvement in the durability of springs 8a to 8d and suppresses vibration of the pair of elastic deformation parts 82a and 82b in their entirety. Note that, the shape of the connection part is not limited to the shape described above. For example, the connection part may have a gently curved arc shape.

Next, springs 8c and 8d will be described. Each of springs 8c and 8d includes inner-side fixing part 83, outer-side fixing part 84, a pair of elastic deformation parts 82c and 82d, and connection part 85b.

Inner-side fixing part 83 is fixed to lens guide 5. Specifically, inner-side fixing part 83 has a plate shape extending in the up-down direction. Inner-side fixing part 83 of spring 8c is fixed to a rear end surface of left wall part 52 in lens guide 5. Further, inner-side fixing part 83 of spring 8d is fixed to a rear end surface of right wall part 53 in lens guide 5.

An upper end part of inner-side fixing part 83 in spring 8c is connected to an end part of connection line 7b via solder 86c (see FIG. 3). Accordingly, spring 8c is connected to left-side coil 63 via connection line 7b. An upper end part of inner-side fixing part 83 in spring 8d is connected to an end part of connection line 7c via solder 86d. Accordingly, spring 8d is connected to right-side coil 64 via connection line 7c.

Outer-side fixing part 84 is fixed to base 32. Outer-side fixing part 84 has a plate shape extending in the up-down direction. Outer-side fixing part 84 of spring 8c is fixed to the rear end surface of left wall part 322 in base 32. Further, outer-side fixing part 84 of spring 8d is fixed to the rear end surface of right wall part 323 in base 32.

A lower end part of outer-side fixing part 84 of spring 8c is connected to first connection part 333 of FPC 33 via solder 86a. Further, a lower end part of outer-side fixing part 84 of spring 8d is connected to second connection part 334 of FPC 33 via solder 86b.

Each pair of elastic deformation parts 82c and 82d of springs 8c and 8d is arranged side by side in a state of having an interval therebetween in the up-down direction and connects inner-side fixing part 83 and outer-side fixing part 84. Specifically, elastic deformation part 82c on the upper side connects the upper end part of inner-side fixing part 83 and outer-side fixing part 81. Further, elastic deformation part 82d on the lower side connects a lower end part of inner-side fixing part 83 and outer-side fixing part 81. Note that, elastic deformation part 82c on the upper side corresponds to an example of the first elastic deformation part. Further, elastic deformation part 82d on the lower side corresponds to an example of the second elastic deformation part.

Each of elastic deformation parts 82c and 82d includes: at least a pair of linear parts 820c and 820d arranged so as to follow each other in a state of having an interval therebetween; and a pair of intermediate connection parts 821c and 821d that connect intermediate parts of the pair of linear parts 820c and 820d in a length direction of the pair of linear parts 820c and 820d to each other. The configurations of the pair of linear parts 820c and 820d and intermediate connection parts 821c and 821d are substantially the same as the configurations of the pair of linear parts 820a and 820b and the pair of intermediate connection parts 821a and 821b in springs 8a and 8b described above so that descriptions thereof will be omitted.

Elastic deformation part 82c includes a first end part connected to the upper end part of inner-side fixing part 83, and a second end part connected to outer-side fixing part 84.

The second end part is connected to a portion near an upper end of outer-side fixing part 84 in the up-down direction. The second end part of elastic deformation part 82c is arranged downward from the first end part of elastic deformation part 82a.

Elastic deformation part 82d includes a first end part connected to the lower end part of inner-side fixing part 83, and a second end part connected to outer-side fixing part 84. The second end part of elastic deformation part 82c is arranged upward from the first end part of elastic deformation part 82a. Further, in outer-side fixing part 84, the second end part of elastic deformation part 82d is connected to a position downward from the position to which the second end part of elastic deformation part 82c is connected.

In the same manner as in elastic deformation parts 82a and 82b, each of elastic deformation parts 82c and 82d includes: first straight line part 821 including the first end part; second straight line part 822 including the second end part; and meandering part 823 that connects first straight line part 821 and second straight line part 822.

The shapes of first straight line part 821, second straight line part 822, and meandering part 823 of elastic deformation parts 82c and 82d are substantially the same as the shapes of first straight line part 821, second straight line part 822, and meandering part 823 of elastic deformation parts 82a and 82b in springs 8a and 8b so that descriptions thereof will be omitted. Further, the configuration of connection part 85b is also substantially the same as the configuration of connection part 85a in springs 8a and 8b so that a description thereof will be omitted. The description of elastic deformation part 82a and 82b described above may be appropriately read as the configurations of elastic deformation parts 82c and 82d.

In lens module 3 having the configuration as described above, when a current flows through left-side coil 63 and right-side coil 64 of AF apparatus 4 via FPC 33, a Lorentz force that displaces left-side coil 63 and right-side coil 64 in the direction of the optical axis (the X direction) is generated.

Then, since left-side coil 63 and right-side coil 64 are fixed to lens guide 5, lens guide 5 moves in the direction of the optical axis (the X direction) based on the Lorentz force described above. Note that, the movement direction of lens guide 5 is switched by controlling the direction of a current flowing through left-side coil 63 and right-side coil 64. Autofocusing is performed in this way.

In the case of the present embodiment, a current flows through, in order from the positive side of the power supply, the terminals of first terminal part 332 in FPC 33, the wirings of board 331 in FPC 33, second connection part 334 in FPC 33, spring 8d, right-side coil 64, left-side coil 63, spring 8c, first connection part 333 in FPC 33, the wirings of board 331 in FPC 33, and the terminals of first terminal part 332 in FPC 33.

When lens guide 5 moves in the direction of the optical axis, each of springs 8a to 8d elastically deforms in the direction of the optical axis (the X direction) to guide the movement of lens guide 5.

According to the present embodiment having the configuration as described above, it is possible to realize camera module 1 including springs 8a to 8d having a high durability while reducing the influence on the drivability of lens guide 5. Hereinafter, the reason for thereof will be described.

It is assumed here that there are two types of springs having the same spring constant and including an elastic deformation part(s). One of the springs is a spring (hereinafter referred to as the spring of the present embodiment) including an elastic deformation part(s) (each) formed by a pair of linear parts as in springs 8a to 8d according to the present embodiment. Further, the other spring is a spring (hereinafter referred to as the spring of the comparative example) including an elastic deformation part(s) (each) formed by one linear part. Since the spring of the present embodiment and the spring of the comparative example have the same spring constant, the influence on the drivability of lens guide 5 is substantially the same.

In a case where an impact is applied to camera module 1, the one linear part in the spring of the comparative example absorbs the impact while elastically deforming. At this time, stress concentration based on the impact is likely to occur in the one linear part. In the case of the spring of the present embodiment, on the other hand, an impact applied to camera module 1 is dispersed in the pair of linear parts and is absorbed thereby. At this time, the pair of linear parts absorbs the impact while elastically deforming in aspects different from each other. Thus, since an impact is dispersed in the pair of linear parts in the case of the spring of the present embodiment, occurrence of stress concentration in the elastic deformation part(s) is suppressed. As a result, the durability of the spring improves. As described above, the present embodiment makes it possible to realize a camera module including a spring(s) having a high durability while suppressing the influence on the drivability of lens guide 5.

### Additional Note

Although a smartphone that is a camera-equipped mobile terminal has been described as an example of the camera-mounted apparatus including camera module 1 in each embodiment described above, the present invention is applicable to a camera-mounted apparatus that includes: a camera module; and an image-processing part that processes image information obtained by the camera module. The camera-mounted apparatus encompasses information apparatuses and transport apparatuses. The information apparatuses include, for example, camera-equipped mobile phones, notebook computers, tablet terminals, portable game machines, webcams, and camera-equipped in-vehicle apparatuses (such as rear-view monitor apparatuses and dashboard camera apparatuses). Further, the transport apparatuses include, for example, automobiles.

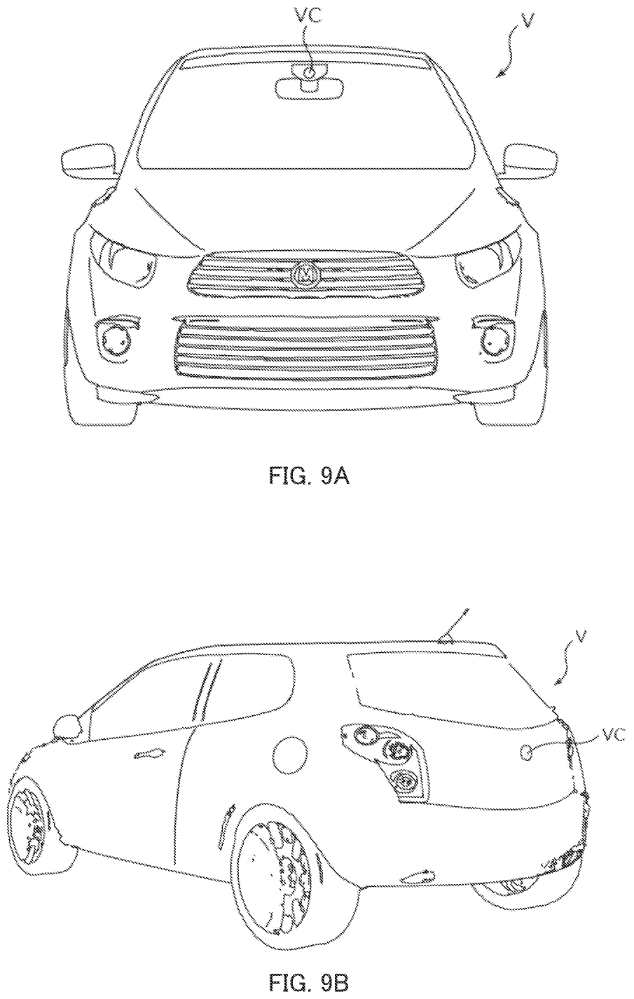

FIGS. 9A and 9B illustrate automobile V as a camera-mounted apparatus in which in-vehicle camera module vehicle camera (VC) is mounted. FIG. 9A is a front view of automobile V, and FIG. 9B is a rear perspective view of automobile V. In automobile V, camera module 1 described in the above embodiment is mounted as in-vehicle camera module VC. As illustrated in FIGS. 9A and 9B, in-vehicle camera module VC is attached to the windshield so as to face the front side, or is attached to the rear gate so as to face the rear side, for example. This in-vehicle camera module VC is used for a rear-view monitor, a dashboard camera, collision-prevention control, automated driving control, and the like.

### INDUSTRIAL APPLICABILITY

An optical actuator and a camera module according to the present invention can be mounted in a smartphone, a mobile phone, a digital camera, a notebook computer, a tablet terminal, a portable game machine, and a thin camera-mounted apparatus such as an in-vehicle camera, for example.

### REFERENCE SIGNS LIST

1 Camera module
2 Optical path bending module
21 Prism
3 Lens module
31 Cover
32 Base
321 Bottom wall part
321a Element arrangement part
322 Left wall part
322a Left-side magnet holding part
323 Right wall part
323a Right-side magnet holding part
33 FPC
331 Board
332 First terminal part
333 First connection part
334 Second connection part
34 Lens part
4 AF apparatus
5 Lens guide
50 Bottom wall part
51 Upper wall part
52 Left wall part
521 Left-side coil fixing part
53 Right wall part
531 Right-side coil fixing part
54 Magnet arrangement part
6 AF actuator
61 Left-side magnet
62 Right-side magnet
63 Left-side coil
64 Right-side coil
65 Position detection element
66 Position detection magnet
7a, 7b, 7c Connection line
8a, 8b, 8c, 8d Spring
80, 83 Inner-side fixing part
801 Upper-side fixing part
802 Lower-side fixing part
81, 84 Outer-side fixing part
82a, 82b, 82c, 82d Elastic deformation part
820a, 820b, 820c, 820d Linear part
821a, 821b, 821c, 821d Intermediate connection part
821 First straight line part
822 Second straight line part
823 Meandering part
823a First curved part
823b Second curved part
823c Third curved part
824a, 824b Maximum curvature part
85a, 85b Connection part
86a, 86b, 86c, 86d Solder
9 Imaging element module
91 Sensor holding part
92 Sensor board
93 Control part

1. An optical actuator, comprising:
a fixed-side member;
a movable-side member that is arranged apart from the fixed-side member in a first direction orthogonal to an optical axis, holds a lens part, and moves by power of a driving part; and
an elastic support member that supports the movable-side member with respect to the fixed-side member, wherein
the elastic support member includes an elastic deformation part formed by at least a pair of linear parts arranged so as to follow each other in a state of having an interval between the pair of linear parts.

2. The optical actuator according to claim 1, wherein each of the pair of linear parts includes a meandering part that is curved over an entire length of the meandering part.

3. The optical actuator according to claim 1, wherein the elastic support member includes an intermediate connection part that connects intermediate parts of the pair of linear parts in a length direction of the pair of linear parts to each other.

4. The optical actuator according to claim 1, wherein:
the elastic support member includes a first elastic deformation part and a second elastic deformation part, each of the first elastic deformation part and the second elastic deformation part being formed by the pair of linear parts, and
the elastic support member includes a connection part that connects the first elastic deformation part and the second elastic deformation part.

5. The optical actuator according to claim 4, wherein:
the first elastic deformation part and the second elastic deformation part are arranged side by side in the first direction, and
the connection part connects the first elastic deformation part and the second elastic deformation part in the first direction.

6. The optical actuator according to claim 1, wherein a spring constant of the elastic support member in a direction of the optical axis is smaller than a spring constant of the elastic support member in a direction orthogonal to the direction of the optical axis.

7. The optical actuator according to claim 6, wherein a thickness dimension of the pair of linear parts is smaller than a width dimension of the pair of linear parts.

8. A camera module, comprising:
the optical actuator according to claim 1; and
an imaging element arranged at a stage subsequent to the lens part.

9. A camera-mounted apparatus, comprising:
the camera module according to claim 8; and
a control part that controls the camera module.
